(19) United States
(12) Patent Application Publication
(10) Pub. No.: US 2015/0093102 A1
(43) Pub. Date: Apr. 2, 2015

(54) MONITORING APPARATUS, MONITORING SYSTEM, AND MONITORING METHOD

(71) Applicant: PANASONIC CORPORATION, Osaka (JP)

(72) Inventors: Takae OGUCHI, Fukuoka (JP); Tetsuo TAYAMA, Fukuoka (JP); Eimei NAMMA, Fukuoka (JP); Tohru TAKAHASHI, Fukuoka (JP)

(73) Assignee: PANASONIC CORPORATION, Osaka (JP)

(21) Appl. No.: 14/039,198

(22) Filed: Sep. 27, 2013

(51) Int. Cl. G03B 5/00

(52) U.S. Cl. CPC G03B 5/00
USPC 396/435

(57) ABSTRACT

A monitoring apparatus is connected to a shutter which opens and closes to limit a capturing area of an image capturing device. The monitoring apparatus detects an event indicative of a closing event or an opening event, and controls the shutter to open and close based on a given time schedule and the detected event, where the time schedule determines each period for opening and closing the shutter. The monitoring apparatus controls the shutter based on the opening event in response to a detection of the opening event, and controls the shutter based on the time schedule in response to a detection of the closing event when the opening event is last detected before the detection of the closing event.

### BACKGROUND

1. Technical Field

The present invention relates to a monitoring apparatus, a monitoring system, and a monitoring method.

2. Background Art

In a related art, a camera system that includes a camera device and a shutter which covers the camera device, and exposes or obstructs the camera lens depending on the opening and closing of the shutter, is known. In the camera system, in a case where the shutter is in a closed state, the camera lens is obstructed and privacy of a person who is present in the image capturing area of the camera device can be protected. In a case where the shutter is in an open state, the camera lens is exposed and an image of a subject that is present in the image capturing area of the camera device is captured, and then security can be protected.

### SUMMARY

In the camera system of the related art, it is insufficient to protect the privacy or to secure the security.

An aspect of the present invention provides a monitoring apparatus for controlling a shutter to open or close in accordance with an event and a given time schedule.

According to the aspect of the present invention, it is possible to improve the level of protecting the privacy or securing the security.

### BRIEF DESCRIPTION OF THE DRAWINGS

FIG. 1 is a block diagram illustrating a configuration example of a monitoring system in an embodiment.

FIG. 2A is a perspective view illustrating an example of a structure in the vicinity of a camera device and a shutter when the shutter is in an open state in the embodiment.

FIG. 2B is a perspective view illustrating an example of a structure in the vicinity of a camera device and a shutter when the shutter is in an intermediate state in the embodiment.

FIG. 2C is a perspective view illustrating an example of a structure in the vicinity of a camera device and a shutter when the shutter is in the closed state in the embodiment.

FIG. 2D is a cross-sectional view illustrating an example of a structure in the vicinity of a camera device and a shutter in the embodiment.

FIG. 3 is a block diagram illustrating a configuration example of a control device in the embodiment.

FIG. 4 is a block diagram illustrating a configuration example of a camera device in the embodiment.

FIG. 5 is a schematic diagram illustrating an example of an arrangement of camera devices, an example of an arrangement of sensors, an example of image capturing areas of the camera devices, and an example of detection ranges of the sensors in the embodiment.

FIG. 6 is a schematic diagram illustrating an example of an information table which shows the relationship between each sensor and a preset position of each camera device in the embodiment.

FIG. 7 is a block diagram illustrating a configuration example of a visiting and leaving management system in the embodiment.

FIG. 8 is a flowchart illustrating an example of an operation of the visiting and leaving management system in the embodiment.

FIG. 9 is a schematic diagram illustrating an example of a time table that includes information about the opening and closing of the shutter, an implementation state of the image recording, and an implementation state of sound recording in each time zone in the embodiment.

FIG. 10 is a flowchart illustrating a first example of operation of the control device in a case where the shutter is open and closed in the embodiment.

FIG. 11 is a flowchart illustrating a second example of the operation of the control device in a case where the shutter is open and closed in the embodiment.

FIGS. 12A and 12B are schematic diagrams illustrating examples of operation modes, a status of event occurrences, an opening and closing status of the shutter, and the implementation states of the sound and image recording in each time zone specified in the time table in the embodiment.

FIG. 13 is a flowchart illustrating a third example of operation of the control device in a case where the shutter is opened and closed in the embodiment.

FIG. 14 is a flowchart (continuation of FIG. 13) illustrating a third example of operation of the control device in a case where the shutter is opened and closed in the embodiment.

### DETAILED DESCRIPTION

Hereinafter, an embodiment of the present invention will be described with reference to the drawings.

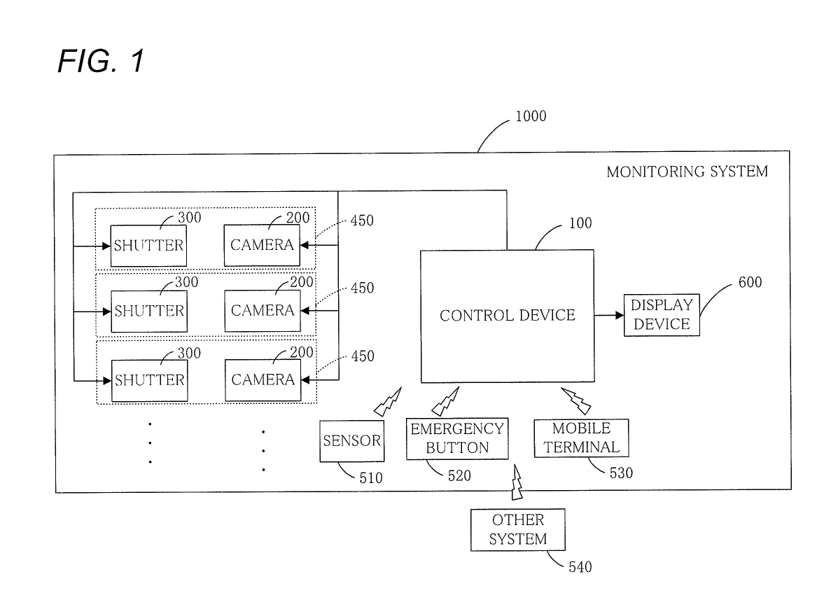

FIG. 1 is a block diagram illustrating a configuration example of a monitoring system 1000 in the embodiment. The monitoring system 1000 includes a control device 100, a camera device 200, a shutter 300, a sensor 510, an emergency button 520, a mobile terminal 530, and a display device 600. The sensor 510, the emergency button 520, or the mobile terminal 530 can be omitted.

The control device 100 is, for example, disposed in the monitoring center and operates as a monitoring server. Alternatively, the control device 100 may be, for example, disposed for each camera device 200 or for each predetermined area where one or more camera devices 200 are arranged, and may be in cooperation with the central server of the monitoring center.

The camera device 200 is installed on the wall or ceiling of, for example, various facilities, a predetermined room in the facilities, or a predetermined area of the room in the facilities. The camera device 200 is, for example, capable of rotating in a panning direction and in a tilting direction, and captures an image of a subject which is present in a predetermined area. The camera device 200, for example, includes an omni-directional camera and a PTZ camera and operates as a network camera.

The PTZ camera is a camera capable of changing the image capturing direction and the image capturing area by a PTZ operation. The PTZ operation is an operation that includes at least one of panning (P), tilting (T), and zooming (Z). In addition, the PTZ camera is controlled in PTZ by the control device 100. The PTZ control is a control that includes at least one of the panning control (P), the tilting control (T), and the zooming control (Z).

The shutter 300 is driven by a drive member in response to the instruction signal from the control device 100 and then opened and closed. Therefore, the shutter 300 limits the image capturing area captured by the camera device 200. Namely, the image capturing area is narrowed when the shutter 300 closes, and the image capturing area is widened when the shutter 300 opens.

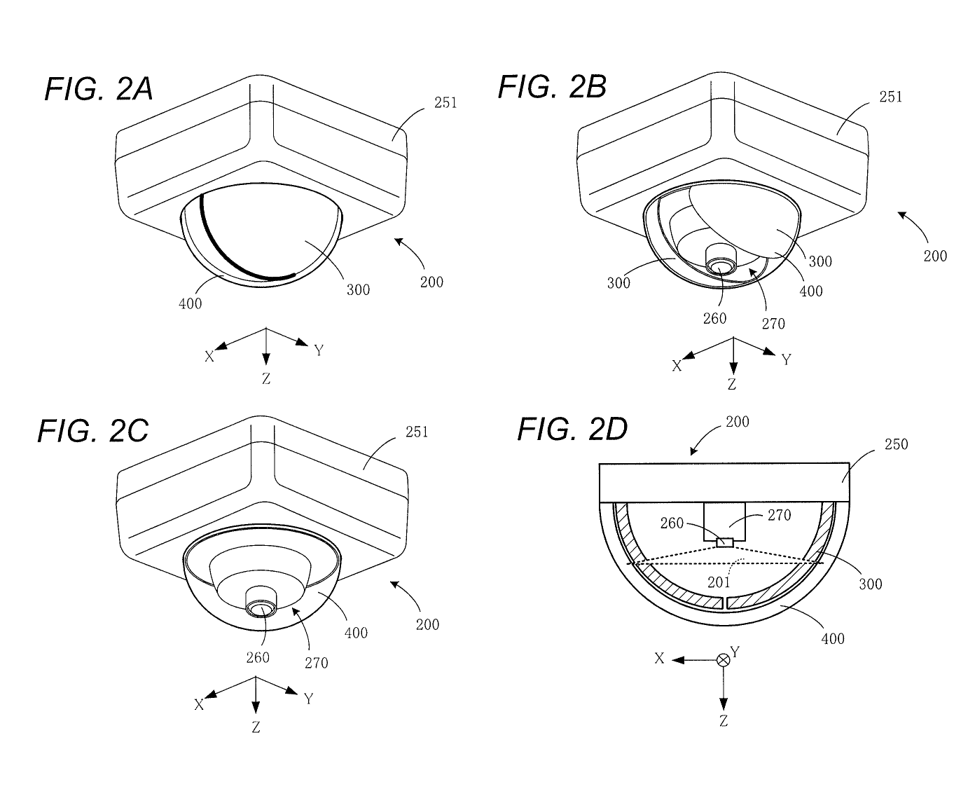

The shutter 300, in a closed state, visually obstructs the front surface of the camera lens 260 (refer to FIG. 2A) in the image capturing direction of the camera device 200. As a result, the image capturing by the camera device 200 becomes impossible. In addition, the shutter 300, in an open state, visually opens the front surface of the camera lens 260 (refer to FIG. 2C) in the image capturing direction of the camera device 200. As a result, the image capturing by the camera device 200 becomes possible.

When the shutter 300 is in the open state, the camera lens 260 is in a state of being visible and recognizable by a person who is present in the area where the camera device 200 is disposed. The shutter 300 may be in an intermediate state in which a part of the image capturing area of the camera device 200 is limited (refer to FIG. 2B). In the intermediate state, there may be a plurality of states according to a degree of limitation.

Another example of the structure of the shutter 300 is, for example, described in U.S. Pat. No. 8,123,419, the contents of which are incorporated herein by reference.

One or more camera devices 200 and shutters 300 are respectively provided in the monitoring system 1000. For example, one shutter 300 is provided for each camera device 200. The shutter 300 may not be provided separately from the camera device 200, but the shutter 300 and the camera device 200 may be configured integrally with each other as illustrated by a reference numeral 450 in FIG. 1.

The sensor 510 includes various sensors that measure, for example, a mechanical, an electromagnetic, a thermal, an acoustic, or a chemical property in the predetermined area, and convert the measured result to a predetermined signal. The sensor 510 broadly includes, for example, a motion sensor, a smoke sensor (a smoke detector), a human sensor, a door opening and closing sensor, a window opening and closing sensor, an infrared sensor, a light sensor, a magnetic sensor, a temperature sensor, a voice sensor, a distance measuring sensor, a position sensor, and other sensors.

The emergency button 520 includes, for example, an emergency button fixedly installed in the predetermined area.

The mobile terminal 530 includes, for example, a smart phone, a personal digital assistant, a pendant microphone (a pendant-type infrared wireless microphone), various remote controllers, a portable emergency warning apparatus, a personal computer (PC), and other operational equipment.

Another system 540 includes, for example, a visiting and leaving management system that manages the visiting and leaving to and from the room in a predetermined area, and an authentication system that authenticates a person to enter a predetermined area.

In a case where the sensor 510 detects predetermined information, the sensor 510, for example, informs the control device 100 of the predetermined information via the network.

The emergency button 520 is pressed by a person who is present in a predetermined area, and for example, informs the control device 100 of the information indicating that the emergency button 520 is pressed, via the network.

The sensor 510 or the emergency button 520 may be incorporated in the camera device 200. Alternatively, one or more sensors 510 or the emergency buttons 520 may be provided for each predetermined area, or one or more sensors 510 or the emergency buttons 520 may be provided for each camera device 200.

The mobile terminal 530 is, for example, possessed by a user, and includes a communication unit, operation unit, control unit, and various sensors. The mobile terminal 530 informs, for example, when predetermined information is detected or a predetermined button is pressed, the control device 100 of the predetermined information or the information indicating that the predetermined button is pressed, via the network.

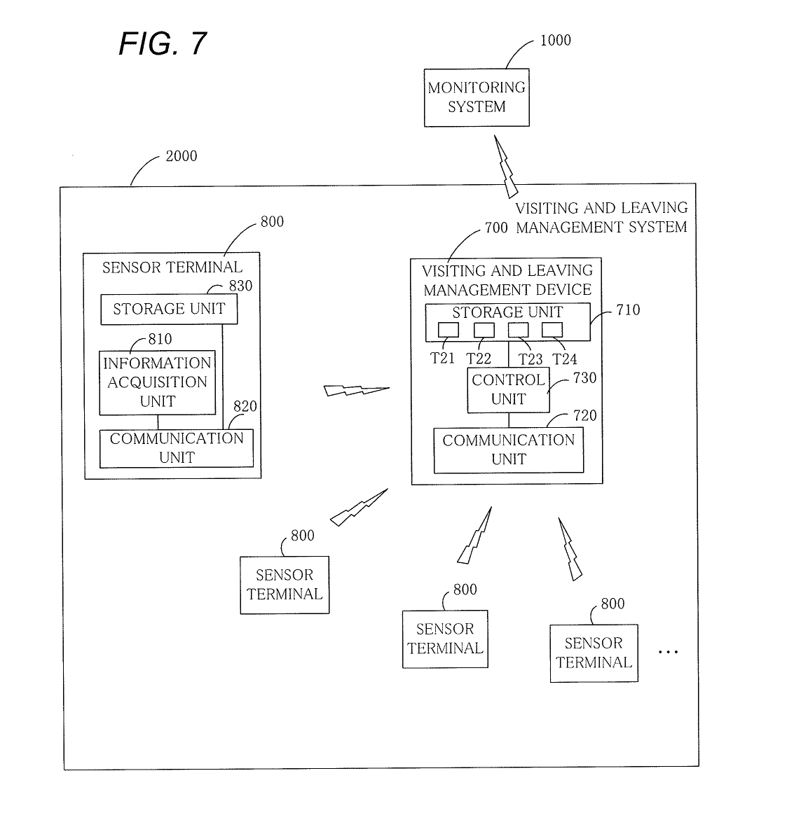

The other system 540 includes, for example, various systems provided separately from the monitoring system 1000 (for example, the visiting and leaving management system 2000 (refer to FIG. 7) and the authentication system). The other system 540 informs the control device 100 in the monitoring system 1000, for example, of the information obtained by the processing in the other systems 540 via, for example, the network.

The information from at least one of the sensor 510, the emergency button 520, the mobile terminal 530, and the other systems 540 may be reported to the camera device 200 instead of being reported to the control device 100.

The display device 600 is disposed, for example, at the monitoring center. As a result, a security guard can visually recognize and monitor the predetermined area. The display device 600 may be, for example, a large screen display installed at the monitoring center or may be a small display on a mobile terminal which the security guard has for security activity. In the display device 600, for example, a plurality of areas may be displayed on the divided screen, or a captured image of one area combined with information about the area may be displayed on the screen.

For example, warning information may be displayed on the display device 600 in a case where a threat occurs in a predetermined area. Alternatively, the warning information may be transmitted to another communication device, and inform by, for example, image or sound, instead of being displayed on the display device 600.

Next, an example of a structure in the vicinity of the camera device 200 and the shutter 300 will be described. FIGS. 2A to 2D are perspective views illustrating the structure in the vicinity of the camera device 200 and the shutter 300. FIG. 2A illustrates a case of the shutter 300 being in an open state. FIG. 2B illustrates a case of an intermediate state where the shutter 300 is in the state between the open state and the closed state. FIG. 2C illustrates a case of the shutter 300 being in a closed state. FIG. 2D is a cross-sectional view illustrating the example of the structure in the vicinity of the camera device 200 and the shutter 300 illustrated in FIG. 2A.

In FIGS. 2A to 2D, the camera device 200 includes at least an optical unit 270 and a camera base 250. The camera device 200 is covered with a housing 251 and a transparent cover 400. The camera device 200 is installed and fixed, for example on the wall or ceiling in a predetermined area.

The optical unit 270 is mounted on the camera base 250 via a predetermined holding mechanism. The optical unit 270 includes a camera lens 260 and a lens holder. An unillustrated board is incorporated in the camera base 250. Various electronic components are mounted on the board. The electronic components include, for example, components for supplying a power to the components in the camera device 200, outputting some images, or executing image processing, and include a digital signal processor (DSP) as described later.

FIG. 2A illustrates the state of the shutter 300 being closed. In this case, since the shutter 300 has a substantially semispherical dome-shape, the optical unit 270 cannot be visually recognized from the surroundings. In addition, in a case where the shutter 300 is in the closed state, an image capturing area 201 of the camera device 200 is limited to the inside of the shutter 300, which is the state of the image capturing being impossible.

The open and closed state of the shutter 300 is changed by a drive member (not illustrated). In a case where the shutter 300 is in the open state by an operation of the drive member as illustrated in FIG. 2C, at least a part of the substantially dome-shaped shutter 300 is opened along the substantially semispherical surface from the front of the image capturing direction, and is accommodated, for example, in the camera base 250. In a case where the shutter 300 is in the open state, the optical unit 270 can be visually recognized from the front of the image capturing direction. In a case where the camera base 250 is mounted on the ceiling, for example, it means that the front of the image capturing direction is a downward direction (positive direction on a Z-axis).

The camera base 250 may include a drive member for opening and closing the shutter 300. The board may be incorporated in the optical unit 270.

The transparent cover 400 is formed of, for example, a transparent material and a translucent material, and surrounds the shutter 300 which houses or exposes the camera device 200. The optical unit 270 is, even in a case where the shutter 300 is in the open state, surrounded by the camera base 250 (refer to FIG. 2A) and the transparent cover 400. The transparent material and the translucent material include, for example, polymethyl methacrylate (PMMA) and polycarbonate (PC).

By covering the optical unit 270 with the transparent cover 400, the camera device 200 can have, for example, excellent waterproofness, dust resistance and light resistance. By applying a hydrophilic coating on the surface of the transparent cover 400, it is possible to improve weather resistance of the transparent cover 400 itself. In addition, influence by the transparent cover 400 on the captured image is equal to or lower than a predetermined level, and it is possible to sufficiently secure the security by analyzing the captured image.

Next, the configuration example of the control device 100 will be described.

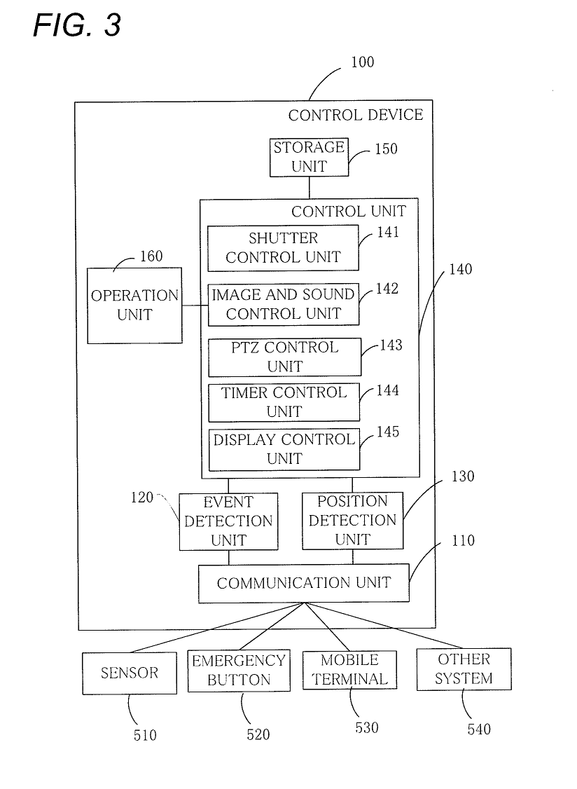

FIG. 3 is a block diagram illustrating the configuration example of the control device 100. The control device 100 includes a communication unit 110, an event detection unit 120, a position detection unit 130, a control unit 140, a storage unit 150, and an operation unit 160.

The communication unit 110 communicates various kinds of information, for example, with the sensors 510, the emergency button 520, the mobile terminal 530, or the other system 540. The communication unit 110 may communicate via the wired network or via the wireless network. In addition, the communication unit 110 may perform communication such as infrared communication, short range communication, and others.

The communication unit 110 receives the measured information measured by the sensors 510 or information indicating that the emergency button 520 is pressed. In addition, for example, the communication unit 110 receives the information detected by the mobile terminal 530 or the information indicating that a predetermined button is pressed. In addition, the communication unit 110 receives the information obtained by a processing in the other system 540.

The event detection unit 120 detects an event of opening and closing of the shutter 300 based on information received by the communication unit 110 from each device. The event includes, for example, an opening event for opening the shutter 300 and a closing event for closing the shutter 300. For example, the opening event is detected in a case where the threat level is comparatively high, and the closing event is detected in a case where the threat level is comparatively low. The state where the threat level is comparatively high includes, for example, a state where the sensor 510 reacts, and the state where the threat level is comparatively low includes, for example, a state where the sensor 510 does not react.

The event detection unit 120 determines that it is the opening event in a case where, for example, the emergency button 520 is pressed and the emergency warning is received by the communication unit 110 and in a case where information of an authentication error is received by the communication unit 110. In addition, the event detection unit 120 determines that it is the opening event in a case where, for example, a suspicious person enters the predetermined area (for example, in a classroom) and the information is reported by a teacher's mobile terminal. In addition, the event detection unit 120 determines that it is the opening event in a case where, for example, a suspicious person is detected in the visiting and leaving management system or in a case where an authentication error is detected in the authentication system.

In addition, the event detection unit 120 determines that it is the closing event in a case where, for example, the teacher in class requests via a smart phone for the shutter 300 to be closed for the protection of the privacy, and the request signal is received by the communication unit 110. In addition, the event detection unit 120 determines that it is the closing event in a case where a predetermined amount of time has passed since the opening event is detected (received).

The position detection unit 130 identifies a device that transmits the information received by the communication unit 110, and detects a position where the device exists or is installed. The position may be detected, for example, using an Internet Protocol (IP) address of the camera device 200 arranged in a predetermined area or a Media Access Control (MAC) address. In addition, the position may be detected using a host name that is uniquely given to the camera device 200. In addition, for example, in a case where the device is a mobile device, the position may be detected using the Global Positioning System (GPS).

The control unit 140 integrally administrates each unit in the control device 100. In addition, the control unit 140 includes a shutter control unit 141, an image and sound control unit 142, a PTZ control unit 143, a timer control unit 144, and a display control unit 145. The control unit 140 realizes various functions by, for example, a control program stored in the storage unit 150 being executed by a CPU.

The shutter control unit 141 controls the opening and closing of the shutter 300. The image and sound control unit 142 controls such that the image captured by the camera device 200 is recorded, or the voice collected by the microphone is recorded.

The PTZ control unit 143 instructs the camera device 200 to perform, for example, the PTZ control in a predetermined timing. For example, the PTZ control unit 143 controls the image capturing area or the image capturing direction of the camera device 200 according to the position information of the sensor 510 which detects a predetermined event.

The timer control unit 144 measures, for example, current time or any period of time. For example, the display control unit 145 generates a display screen from the image captured by the camera device 200, and instructs the display device 600 so as to display the display screen, according to the screen size of the display device 600.

The storage unit 150 stores various kinds of information, various programs, and information about various tables. In addition, for example, information of the image captured by the camera device 200 and information of the voice collected by the camera device 200 may be obtained from the camera device 200 via the communication unit 110, and may be stored in the storage unit 150.

The operation unit 160 receives various operations. As an operation unit 160, which can instruct the control unit 140, for example, a key input unit, a predetermined button, a mouse, a keyboard, a microphone, and a touch panel can be considered.

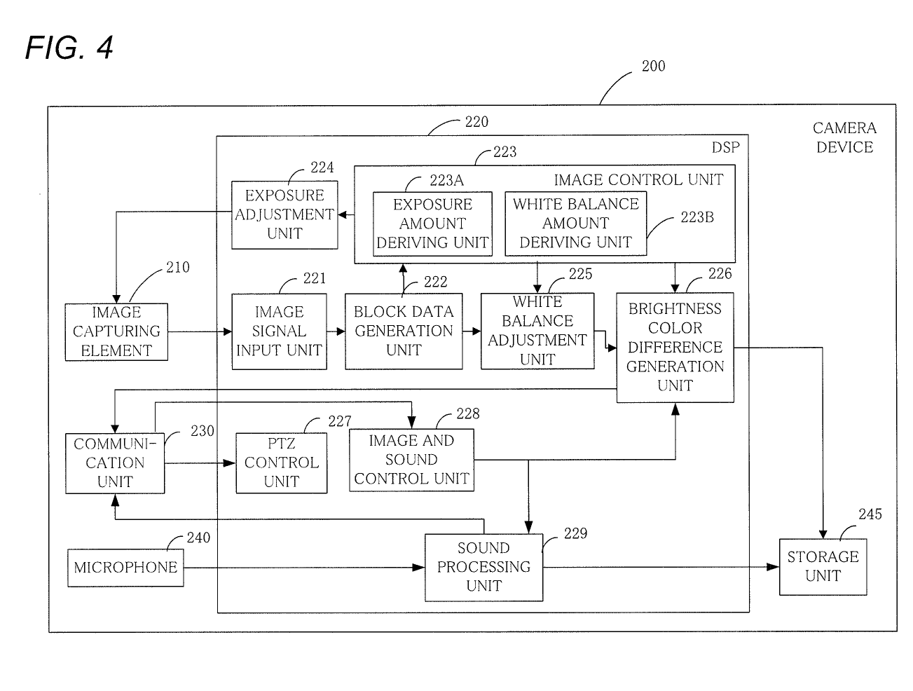

Next, a configuration example of the camera device 200 will be described. FIG. 4 is a block diagram illustrating the configuration example of the camera device 200. The camera device 200 includes an image capturing element 210, a Digital Signal Processor (DSP) 220, and a communication unit 230.

The image capturing element 210 includes, for example, a Charge Coupled Device (CCD) or a Complementary Metal Oxide Semiconductor (CMOS) image sensor. The DSP 220 performs a predetermined signal processing with respect to the image signal obtained from the image capturing element 210.

The communication unit 230 is connected to the control device 100 via the network, and communicates with the control device 100 on various kinds of information. The network may be either a wired network or a wireless network. The communication unit 230 receives, for example, information about the direction of the camera device 200, or control information (for example, panning control information, tilt control information or zoom control information) which controls the image capturing area, from the control device 100.

In addition, the communication unit 230 may receive, for example, detection information or information about the detection result from the sensor 510, the emergency button 520, the mobile terminal 530, and at least one of the other systems 540. In this case, the communication unit 230 transmits the received information to the control device 100, and the opening and closing control of the shutter 300 is performed by the control device 100.

In the present embodiment, the shutter 300 is controlled by the control device 100. Alternatively, the shutter 300 may be controlled by the camera device 200. In this case, the control signal is transmitted to the shutter 300 from the communication unit 230, and the opening and closing control of the shutter 300 is performed.

The microphone 240 acquires a sound signal (for example, a voice) surrounding the microphone 240 to convert the signal to an electric signal.

The storage unit 245 stores various kinds of information, various programs, and information about various tables. In addition, the information about the camera device 200 kept in the control device 100 may be kept in the storage unit 245 of the camera device 200.

The DSP 220 includes an image signal input unit 221, a block data generation unit 222, an image control unit 223, an exposure adjustment unit 224, a white balance adjustment unit 225, and a brightness color difference generation unit 226. In addition, the DSP 220 includes a PTZ control unit 227, an image and sound control unit 228, and a sound processing unit 229.

The image signal input unit 221 receives an image signal from the image capturing element 210. The block data generation unit 222 divides all of the pixels of the image capturing element 210 into a plurality of blocks with a predetermined size, adds a pixel value to a color filter (each RGB filter) for each divided block, and generates block data.

The image control unit 223 includes, for example, an exposure amount deriving unit 223A and a white balance amount deriving unit 223B. The exposure amount deriving unit 223A receives the block data from the block data generation unit 222 and derives (for example, calculates) an exposure amount based on the block data. The white balance amount deriving unit 223B receives the block data from the block data generation unit 222 and derives a white balance amount based on the block data.

The exposure adjustment unit 224 adjusts the exposure amount of the image capturing element 210 using the exposure amount derived by the exposure amount deriving unit 223A. The white balance adjustment unit 225 adjusts the white balance of the block data using the white balance amount derived by the white balance amount deriving unit 223B.

The brightness color difference generation unit 226 generates brightness data Y, and color difference data Cb and Cr as exemplified below is adjusted, from the block data (RGB data) of the white balance.

Y=0.299×R+0.587×G+0.114×B

Cb=−0.169×R−0.331×G+0.500×B

Cr=0.500×R−0.419×G−0.081×B

The PTZ control unit 227 controls, for example, the direction of the camera device 200 based on the control information received by the communication unit 230. For example, the PTZ control unit 227 may control the direction in a horizontal direction of the camera device 200 based on the panning control information from the control device 100. In addition, the PTZ control unit 227 may control the direction in a vertical direction of the camera device 200 based on the tilt control information from the control device 100. The PTZ control unit 227 causes, for example, a motor (not illustrated) to rotate and causes the camera device 200 to pan or tilt for each predetermined angle.

In addition, the PTZ control unit 227 may control the image captured by the camera device 200 so as to be enlarged (zoom-in) or reduced (zoom-out) based on the zoom control information from the control device 100. In a case where the direction of the camera device 200 is controlled, the direction of the entire camera device 200 may be controlled or the direction of the camera lens 260 of the camera device 200 may be controlled.

In a case where the camera device 200 is an omni-directional camera, the PTZ control in the camera device 200 is implemented in software.

The image and sound control unit 228, for example, controls such that the image captured by the image capturing element 210 is recorded and the voice collected by the microphone 240 is recorded in the storage unit 245, according to the instruction signal (control signal) from the control device 100. In addition, the image and sound control unit 228, for example, controls such that the recording of the captured image is stopped and the recording of the collected voice is stopped according to the instruction signal from the control device 100.

The recorded image or sound information to be stored in the storage unit 245 may be stored in other memory than the storage unit 245. For example, the information may be stored in an external storage medium such as an SD card mounted on the camera device 200 or the like. In addition, for example, the information may be transmitted to the control device 100 and be kept in the control device 100.

The sound processing unit 229 performs a predetermined signal processing with respect to an electric signal from the microphone 240.

Moreover, the case where the microphone 240 collecting the surrounding sound in the predetermined area is included in the camera device 200 is illustrated. However, the microphone 240 may be provided separate from the camera device 200.

Next, the environment for installation of the camera device 200 will be described.

The camera device 200 is, for example, installed on the ceiling or on the wall surface in a predetermined privacy-sensing area where both the security securing and the privacy protection are required. The privacy-sensing area is one of the predetermined areas. The privacy-sensing area is, for example, a part or the whole of a company, a classroom, a restroom, a dressing room, a library, a locker room, or a conference room.

In each privacy-sensing area, a privacy threshold value is assigned depending on importance of the privacy protection. For example, when the importance of the privacy protection is higher, a larger value is assigned as a privacy threshold value, and when the importance of the privacy protection is lower, a smaller value is assigned as a privacy threshold value. For example, in the privacy-sensing area such as in a restroom or a dressing room, a comparatively larger privacy threshold value is assigned, and in the privacy-sensing area such as in a library, a comparatively smaller privacy threshold value is assigned. When the privacy threshold value assigned is comparatively large, for example, in a case where a predetermined event is detected by a plurality of sensors 510, the shutter 300 is merely opened but the captured image is not recorded. Thus the privacy can be protected as much as possible. In addition, when the privacy threshold value assigned is comparatively small, for example, even in a case where a predetermined event is detected by one sensor 510, the captured image is recorded while the shutter 300 is opened. Thus, the privacy is not protected compared to the case where the privacy threshold value is large.

For example, for each privacy-sensing area, one or more camera devices 200 are installed. In addition, the camera device 200 for which the privacy-sensing area is included in the image capturing area may be installed outside the privacy-sensing area.

In addition, the sensor 510 and the emergency button 520 may be installed, for example, in the privacy-sensing area. The mobile terminal 530 may, for example, be owned by a user located in the privacy-sensing area. At least a part of the other system 540, for example, may or may not be installed in the privacy-sensing area.

The image capturing area of the camera device 200 includes, for example, at least a part of the detection range of one or more sensors 510 installed in a fixed manner or at least a part of the target warning range of the emergency button 520. Each camera device 200 is preset so that the direction of each camera device 200 is adjusted in such a manner that the predetermined privacy-sensing area is included in the image capturing area. In addition, the number of preset position of each camera device 200 may be more than one, for example, the preset position may be prepared in advance for each sensor 510 which detects the information regarding the occurrence of an abnormality. In this case, for example, the sensor 510 which detects the information regarding the occurrence of the abnormality and the information regarding the preset position of the camera device 200 are stored in the control device 100 or in each camera device 200 in advance in association with each other.

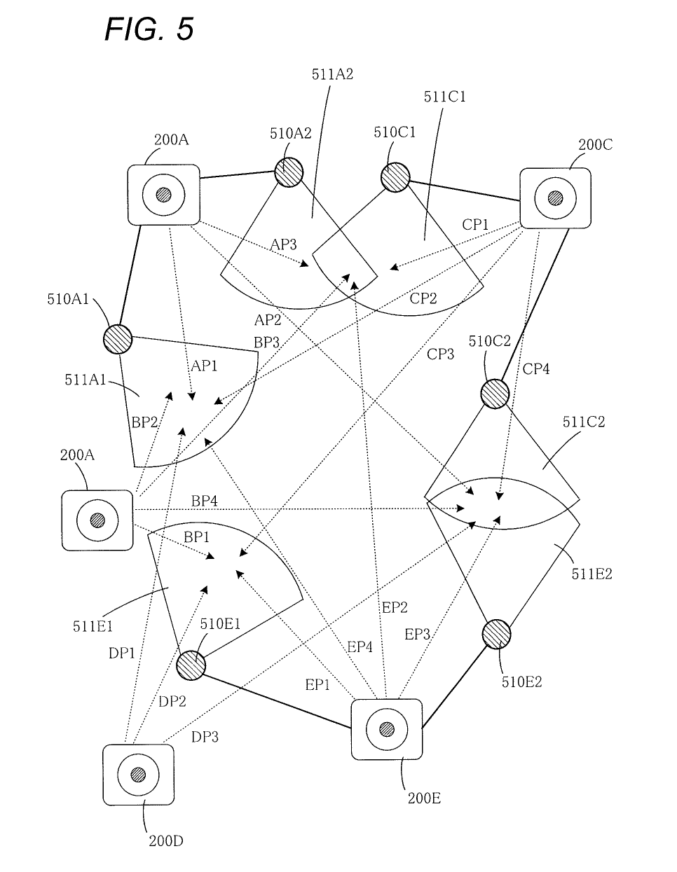

FIG. 5 is a schematic diagram illustrating an arrangement example of the camera devices 200, an arrangement example of the sensors 510, an example of image capturing areas of the camera devices 200, and an example of detection ranges of the sensors 510. As illustrated in FIG. 5, five camera devices 200 (200A to 200E) and 6 sensors (510A1, 510A2, 510C1, 510C2, 510E1, and 510E2) are installed in the privacy-sensing area. Here, a description mainly related to the camera device 200A will be given.

In FIG. 5, the sensors 510A1 and 510A2 are connected to and three preset positions AP1 to AP3 are set to the camera device 200A. The sensors 510C1 and 510C2 are connected to and four preset positions CP1 to CP4 are set to the camera device 200C. The sensors 510E1 and 510E2 are connected to and four preset positions EP1 to EP4 are set to the camera device 200E. Moreover, the sensor 510 is not connected to either of the camera devices 200B or 200D, and four preset positions BP1 to BP4 are set to the camera device 200B and three preset positions DP1 to DP3 are set to the camera device 200D.

For example, the preset position AP1 is corresponding to the detection range 511A1 of the sensor 510A1, preset position AP2 is corresponding to the detection ranges 511C2 and 511E2 of the sensors 510C2, 510E2, respectively, and the preset position AP3 is corresponding to the detection ranges 511A2 and 511C1 of the sensors 510A2 and 510C1, respectively.

That is, when the camera lens 260 of any one of the camera devices 200A to 200E is turned to the preset position AP1, it is possible to capture an image including the detection range 511A1 of the sensor 510A1. In addition, when the camera lens 260 of any one of the camera devices 200A to 200E is turning to the preset position AP2, it is possible to capture an image including the detection ranges 511C2 and 511E2 of the sensors 510C2 and 510E2, respectively. In addition, when the camera lens 260 of any one of the camera devices 200A to 200E is turning to the preset position AP3, it is possible to capture an image including the detection ranges 511A2 and 511C1 of the sensors 510A2 and 510C1.

In FIG. 5, a case where a plurality of the camera devices 200 and the sensors 510 are installed in one privacy-sensing area is illustrated. Alternatively, for example, the privacy-sensing area may be divided by a wall surface, and the camera devices 200 may be installed for each divided privacy-sensing area.

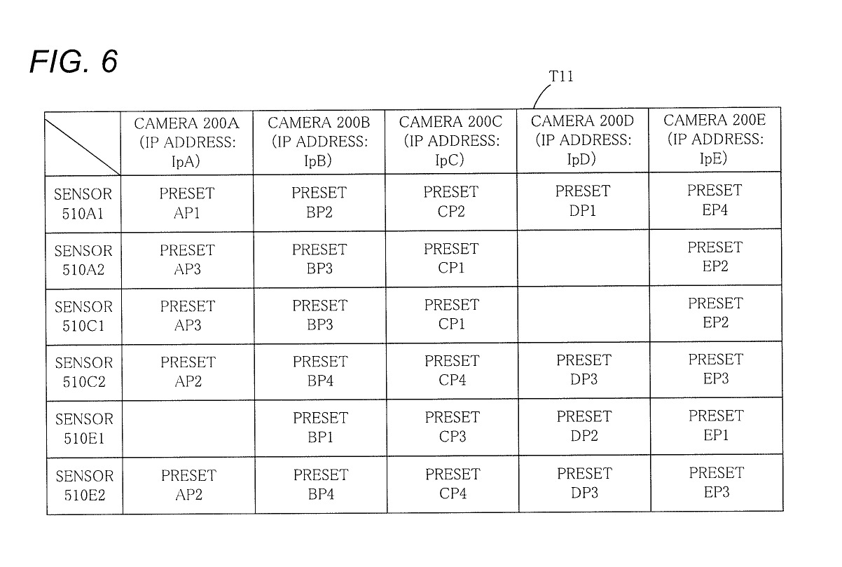

FIG. 6 is a schematic diagram illustrating an example of an information table T11 which indicates the relationship between each sensor 510 and a preset position of each camera device 200. The information table T11 is stored in the storage unit 150.

The information table T11 holds, for example, the identification information (for example, IP address) of each camera device 200A to 200E and the identification information (for example, sensor ID) of each sensor 510 in association with each other. The information table T11 includes, for example, information indicating that the preset position AP1 of the camera device 200A (IP address: IpA) is corresponding to the detection range 511A1 of the sensor 510A1. In addition, the information table T11 includes information indicating that the preset position BP2 of the camera device 200B (IP address: IpB) is corresponding to the detection range 511A1 of the sensor 510A1. In addition, the information table T11 includes information indicating that the preset position CP2 of the camera device 200C (IP address: IpC) is corresponding to the detection range 511A1 of the sensor 510A1. In addition, the information table T11 includes information indicating that the preset position DP1 of the camera device 200D (IP address: IpD) is corresponding to the detection range 511A1 of the sensor 510A1. In addition, the information table T11 includes information indicating that the preset position EP4 of the camera device 200E (IP address: IpE) is corresponding to the detection range 511A1 of the sensor 510A1.

In addition, the control device 100 may hold an information table (not illustrated) in which a sensor of another camera having a common detection range is associated with each sensor 510 (for example, sensor 510A1 and 510A2). In the information table, the sensor 510C1 of the camera device 200C is in associated with the sensor 510A2, the IP address of the camera device 200C is stored.

In FIG. 5, a case where the sensors 510 are connected to the camera devices 200 is illustrated. Alternatively, instead of the sensors 510, the emergency button 520, the mobile terminal 530, or the other system 540 may be connected thereto. In addition, at least two of the sensor 510, the emergency button 520, the mobile terminal 530, or the other system 540 may be mixed in the privacy-sensing area.

The detection range 511 may or may not be overlapped by a plurality of sensors 510. In addition, the image capturing area by a plurality of camera devices 200 may or may not be overlapped.

The control device 100 instructs the camera device 200 (for example, the camera device 200A), with reference to the information table T11, to capture the image of a detection range (for example, the detection range 511A1) where an abnormality is expected to occur, for example.

Next, as one example of the other system 540, the visiting and leaving management system 2000 will be described.

FIG. 7 is a block diagram illustrating a configuration example of a visiting and leaving management system 2000. The visiting and leaving management system 2000 includes, for example, a visiting and leaving management device 700 and a sensor terminal 800. The visiting and leaving management device 700 and one or more sensor terminals 800 are connected to each other via a network.

The visiting and leaving management device 700 manages at least one of the visitors who enter a predetermined area and the leaving persons who leave the predetermined area. Here, it is assumed that the visitors or the leaving persons have IC cards for the management of visiting and leaving, but not limited to the IC card. In addition, for example, the functions of IC cards may be incorporated in the mobile terminal. The sensor terminal 800 is installed inside or outside of the predetermined area where the visiting and leaving is managed.

The sensor terminal 800 includes an information acquisition unit 810, a communication unit 820, and a storage unit 830. The sensor terminal 800 includes, for example, a memory and a processor, and realizes various functions (for example, an IC card reading function, an information transmission function) by the CPU executing a control program stored in the memory. Moreover, each function may be realized by a dedicated hardware instead of the software.

The information acquisition unit 810 acquires various kinds of information. For example, the information acquisition unit 810 is a card reader, and reads the card ID stored in the IC card from the IC card which is held by the bearer of the IC card, and informs the communication unit 820.

The communication unit 820 communicates, for example, various kinds of information to the visiting and leaving management device 700 via a wired network or a wireless network. For example, the communication unit 820 transmits the information about the card ID from the information acquisition unit 810 and the information about the terminal ID which identifies the sensor terminal and is stored in the storage unit 830, to the visiting and leaving management device 700.

The visiting and leaving management device 700 includes a storage unit 710, a communication unit 720, and a control unit 730.

The storage unit 710 stores various kinds of information, various tables, and a control program. The storage unit 710 stores, for example, a sensor signal holding table T21, a card information holding table T22, a visitor information holding table T23, and a leaving information holding table T24. Adding, modifying, and removing data to and from the sensor signal holding table T21 and the card information holding table T22 are implemented based on the input to the operation unit (not illustrated).

The communication unit 720 communicates with another communication device or another system (for example, the monitoring system 1000) via a wired network or a wireless network. For example, with respect to the monitoring system 1000, the communication unit 720 transmits the information on whether or not a person exists in the predetermined area. In addition, with respect to the monitoring system 1000, when a person's visiting or leaving occurs in the predetermined area, the communication unit 720 may sequentially transmit the information on the visiting or leaving (for example, information on the visitor, the leaving person, the visiting time, the leaving time, the visiting area, and the leaving area).

The control unit 730 realizes, for example, various functions (for example, an authentication processing function, a visitor information generation function, and a leaving determination function) by an execution of the control program stored in the storage unit 710 by a CPU. Moreover, various functions may be realized by a dedicated hardware instead of the software. The information on visiting and leaving is held, for example, in the visitor information holding table T23 and the leaving information holding table T24.

The sensor information holding table T21 has information indicating a correspondence between each sensor and the area where each sensor is installed. The sensor information holding table T21 holds, for each sensor terminal 800, for example, information on the sensor ID, the installation area, the area ID, and the name of area in association with each other. The sensor information holding table T21 is referenced in the authentication processing.

The sensor ID is identification information which identifies the sensor terminal 800. The installation area indicates information about the location where the sensor terminal 800 is installed. The area ID is identification information which identifies the area where predetermined information is detected by the sensor terminal 800.

The card information holding table T22 has information indicating a correspondence between the IC card used for visiting and leaving and the area where the visiting and leaving is permitted by each IC card. The card information holding table T22 holds, for each IC card, for example, information on the card ID, the name, and the permitted area ID in association each other. The card information holding table T22 is referenced in the authentication processing.

The card ID is identification information which is recorded in the IC card and identifies the IC card. The name is an IC card bearer's name, for example. The permitted area ID is identification information which identifies the area where the visiting and leaving is permitted by the IC card.

The visitor information holding table T23 has information indicating a correspondence between each visitor and the area each visitor has entered. The visitor information holding table T23 holds, for each visitor, for example, information on the visitor card ID, the visitor's name, the visiting area ID, the visiting area name, and the visiting time in association with each other. The visitor information holding table T23, for example, is referenced in a case where the control unit 730 determines whether the visitor information is recorded or removed, and is updated according to the determination result.

The visitor card ID is identification information which identifies the IC card used when the visitor enters. The ID card is included in the card ID held in the card information holding table T22. The visitor's name is, for example, a name of the visitor. The visiting area ID is identification information which identifies the area where the visitor enters, and is an area ID held in the sensor information holding table T21 in association with the sensor ID of the sensor terminal 800 installed in the area. The visiting area name is the area name held in the sensor information holding table T21 in association with the corresponding area ID.

The leaving information holding table T24 has, for example, at the time point when the shutter 300 is opened, information indicating the leaving status of the visitor who has entered each area, at a predetermined time point. The leaving information holding table T24 holds, for each entering visitor when the shutter 300 is in the open state, the card ID, the name, the area ID, the area name, and the leaving information in association with each other. The leaving information holding table T24 is, for example, referenced when the control unit 730 determines the leaving, and is updated.

The visitor's card ID, the visitor's name and the visiting area name in the leaving information holding table T24, for example, are similar to the visitor's card ID, the visitor's name, and the visiting area name held in the visitor information holding table T23 at the time point when the shutter 300 is in the open state. In addition, the leaving information is information indicating whether the visitor has left or not.

The storage unit 710 may not include the leaving information holding table T24, and when the visitor has left, the control unit 730 may remove the information about the visitor who has left, from the visitor information holding table T23. Even in this case, a person in the area can be recognized.

Here, separately from the monitoring system 1000, a case of the visiting and leaving management system 2000 is described. Alternatively, the configuration units of the monitoring system 1000 and the configuration units of the visiting and leaving management system 2000 may be partly at least in common. For example, at least a part of the storage unit, the communication unit, the control unit, the area (the privacy-sensing area), and the sensor (the sensor terminal) may be partly shared in both systems.

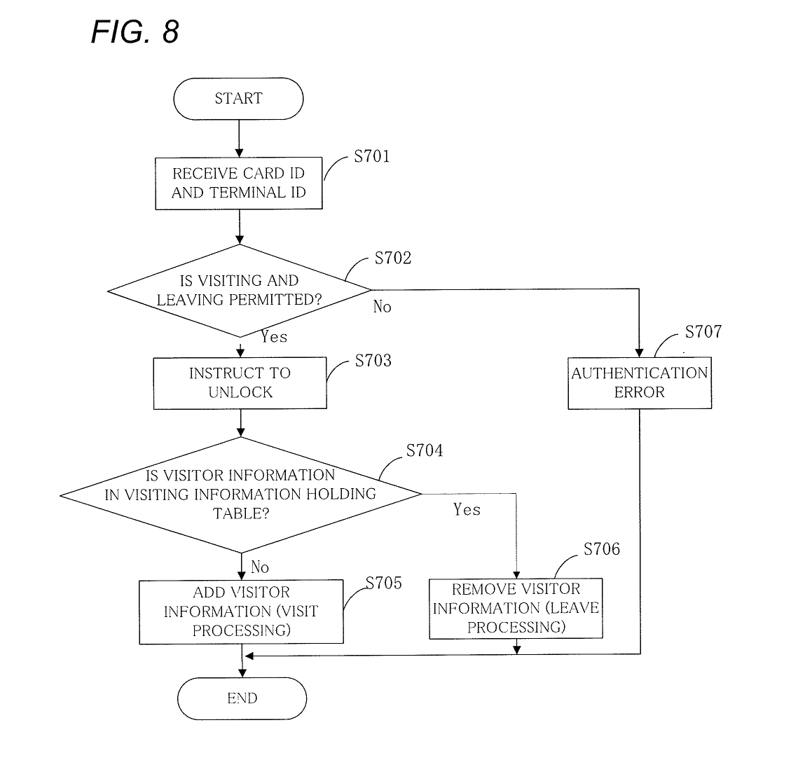

Next, an example of an operation of the visiting and leaving management device 700 will be described. FIG. 8 is a flowchart illustrating the example of the operation of the visiting and leaving management device 700.

First, the communication unit 720 receives the information about the card ID and the terminal ID from the sensor terminal 800 which the IC card approaches (S701).

Subsequently, the control unit 730 determines whether or not the visiting of the area where the sensor terminal 800 which the IC card approaches is installed or the leaving from such area is permitted (S702). For example, the control unit 730 determines whether or not the visiting and leaving is permitted in a case where the area ID held in the sensor information holding table T21 in association with the received terminal ID is included in the permitted area ID held in the card information holding table T22 in association with the received card ID. In a case where the visiting and leaving is not permitted, the control unit 730 determines the authentication error (S707), and the process in FIG. 8 ends.

In a case where the visiting and leaving is permitted, the communication unit 720 transmits, for example, an instruction to the sensor terminal to which the IC card approaches, to unlock the door provided at the predetermined area (S703).

Subsequently, the control unit 730 determines whether or not the visitor information which includes the received card ID and the area ID held in the sensor information holding table T21 in association with the received terminal ID are included in the visitor information holding table T23 (S704).

In a case where the visitor information is not included in the visitor information holding table T23, the control unit 730 adds the visitor information to the visitor information holding table T23, and the visiting process ends (S705).

On the other hand, in a case where the visitor information is included in the visitor information holding table T23, the control unit 730 removes the visitor information from the visitor information holding table T23, and the leaving process ends (S706).

Here, a case where the visitor information about the visitor already entered is removed as a leaving person is illustrated. Alternatively, the visiting and leaving may be determined by the terminal ID. For example, in a case where the IC card approaches the sensor terminal 800 installed in the area other than the predetermined area, the visiting and leaving management device 700 or the sensor terminal 800 may determine that the bearer of the IC card is visiting. In addition, in a case where the IC card approaches the sensor terminal 800 installed in the area within the predetermined area, the visiting and leaving management device 700 or the sensor terminal 800 may determine that the bearer of the IC card is leaving.

In this way, according to the visiting and leaving management system 2000, it is possible to grasp presence or absence of the visitor in the predetermined area. The visiting and leaving management system 2000 may provide the monitoring system 1000 with the information about the visitor in the predetermined area (for example, the information about the presence or the absence of the visitor at least a part of information included in the visitor information holding table T23) via the network. The control device 100 of the monitoring system 1000 acquires, for example, the information about the visitor from the visiting and leaving management system 2000, and may open and close the shutter 300 according to the presence or the absence of the visitor.

Next, the time table T12 held in the storage unit 150 of the control device 100 in the monitoring system 1000 will be described.

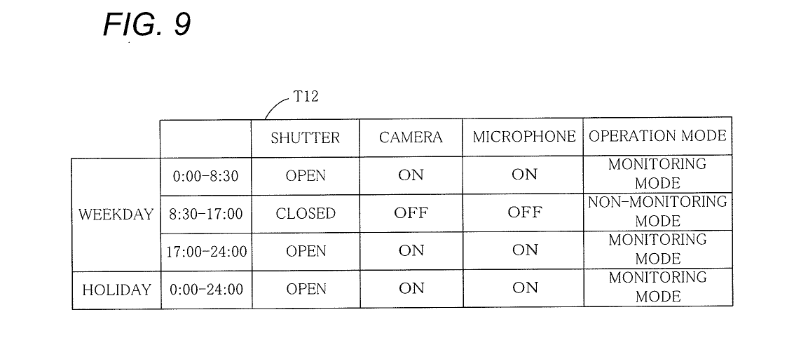

FIG. 9 is a schematic diagram illustrating an example of the time table T12. The time table T12 includes, for example, information about the opening and closing state of the shutter 300, the implementation state of the image recording, and the implementation state of sound recording in each time zone. The time table T12 is stored in the storage unit 150.

In FIG. 9, on holidays, the monitoring system 1000 sets the operation mode as a monitoring mode for the entire day (0:00 to 24:00), implements the sound recording, implements the image recording, and causes the shutter 300 to be in the open state. For example, in a case of monitoring an office, since it is estimated that employees may not be present in the office on holiday, priority to the security can be given in such a time zone.

In addition, as illustrated in FIG. 9, from 08:30 to 17:00 on weekdays, the monitoring system 1000 sets the operation mode as a non-monitoring mode, does not implement the sound recording, does not implement the image recording, and causes the shutter 300 to be in the closed state. For example, in a case of monitoring the office, since it is assumed that employees may be present in the office during work hours, priority to the privacy can be given in such a time zone.

In addition, as illustrated in FIG. 9, in 00:00 to 08:30 and 17:00 to 24:00 on weekdays, the monitoring system 1000 sets the operation mode as the monitoring mode, implements the sound recording, implements the image recording, and causes the shutter 300 to be in the open state. For example, in a case of monitoring an office, since it is estimated that a few employees may be present in the office during work-off hours, priority to the security can be given in that time zone.

Next, the example of operation of the control device 100 in a case where the shutter 300 is open and closed according to the time schedule in the time table T12 will be described. Here, three examples of operation are illustrated. A first example of operation illustrates an example of operation when the shutter 300 is open and closed under the consideration of the schedule. A second example of operation illustrates an example of operation when the shutter 300 is open and closed under the consideration of threat level as an example of an event. A third example of operation illustrates an example of operation when the shutter 300 is open and closed under the consideration of the schedule and the event.

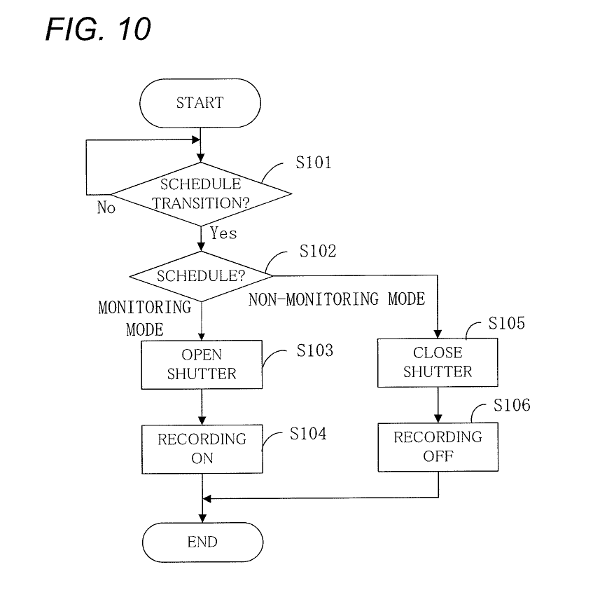

FIG. 10 is a flowchart illustrating an example of the first operation of the control device 100 in a case where the shutter 300 is open and closed.

First, the timer control unit 144 acquires information about the current time. The shutter control unit 141 determines whether or not the current time indicates a time of schedule transition with reference to the time table T12 (S101). In a case where the current time does not indicate the time of schedule transition, the step S101 is performed again.

In a case where the current time indicates the time of schedule transition, the shutter control unit 141 determines, with reference to the time table T12, whether the current time is in the time zone for monitoring mode or in the time zone for non-monitoring mode (S102). The time zone in S102 is the time zone after the schedule transition.

In a case where the current time is in the time zone for monitoring mode, the shutter control unit 141 transmits an instruction signal so as to open the shutter 300 via the communication unit 110 (S103). In addition, the image and sound control unit 142, transmits an instruction signal via the communication unit 110 so as to start collecting the sound by the microphone 240 of the camera device 200 and to start image capturing by the image capturing element 210 (S104).

In a case where the current time is in the time zone for non-monitoring mode, the shutter control unit 141 transmits an instruction signal with respect to the camera device 200 via the communication unit 110 so as to close the shutter 300 (S105). In addition, the image and sound control unit 142 transmits an instruction signal via the communication unit 110 so as to stop collecting the sound by the microphone 240 of the camera device 200 and to stop image capturing by the image capturing element 210 (S106).

According to the first example of operation of the control device 100, the monitoring system 1000 can operate according to the operation modes (monitoring mode and non-monitoring mode) which change depending on the schedule. In a case of the monitoring mode, the priority can be given to the securing of the security. In a case of the non-monitoring mode, the priority can be given to the protection of the privacy.

In FIG. 9 and FIG. 10, a case is illustrated where the image capturing and the sound collecting by the camera device 200 are implemented at the same time. Alternatively, the image capturing and the sound collecting may be implemented at different times. That is, in the monitoring mode, only the sound collecting may be implemented without capturing the image, or only the image capturing may be implemented without collecting the sound.

Next, the example of operation of the control device 100 in a case where the shutter 300 is open and closed depending on the threat level will be described.

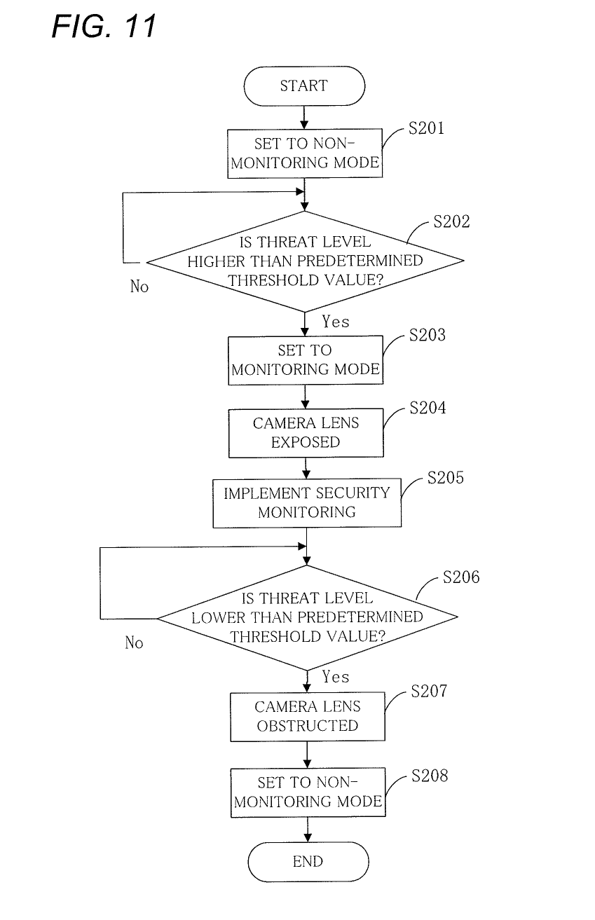

FIG. 11 is a flowchart illustrating a second example of operation of the control device 100 in a case where the shutter 300 is open and closed. Moreover, in the second example of operation, a case where the threat level is high is an example of a case where an opening event occurs. In addition, a case where the threat level is low is an example of a case where the opening event does not occur or a closing event occurs.

In the second example of operation, the control unit 140 basically sets the operation mode of the monitoring system 1000 to the non-monitoring mode (S201). In the non-monitoring mode, the camera lens 260 is physically obstructed from the privacy-sensing area.

In a case where there is a threat at a high level, needs for safety and security take a higher priority than the need for the privacy. The threat at a high level includes, for example, a situation of a hostage or a fired shot. When the threat level exceeds a predetermined threshold value (S202), the control unit 140 transitions the operation mode to the monitoring mode (S203).

The case where the threat level exceeds a predetermined privacy threshold value, for example, includes a case where the emergency button 520 is pressed, a case where the effect that the emergency state is reported from the mobile terminal 530, and a case where a predetermined dangerous state is detected by the sensor 510.

In the monitoring mode, the shutter control unit 141 controls in such a manner that the shutter 300 is open, which enables the camera lens 260 be obstructed, and the shutter 300 moves to the position where the camera lens 260 is exposed (S204). In this way, the camera device 200 can monitor the privacy-sensing area and it is possible to secure the security with respect to the privacy-sensing area where the camera device 200 is disposed (S205).

After the step S205, after passing a predetermined time, for example, when a closing event occurs and the threat level is lower than the predetermined privacy threshold value (S206), the need for the privacy takes a higher priority than needs for the safety and the security. In this case, the shutter control unit 141 controls in such a manner that the shutter 300 is closed, and the shutter 300 returns to the position where the camera lens 260 is obstructed (S207). In addition, the control unit 140 transits the operation mode to the non-monitoring mode (S208).

The case where the threat level is lower than the predetermined threshold value, for example, includes a case where the pressing of the emergency button 520 is stopped, a case where an effect that the emergency state is terminated is notified from the mobile terminal 530, a case where the predetermined dangerous state is not detected by the sensor 510, and a case where a predetermined time has passed since the threat level exceeded the predetermined privacy level threshold value.

According to the second example of operation of the control device 100, in a case where the threat level is comparatively high, it is possible to strengthen the security. In addition, in a case where the threat level is comparatively low, for example, by using the state that the camera device 200 is obstructed from the outside, it is possible to realize the state in which a person in the privacy-sensing area does not feel the discomfort of being monitored.

Next, the third example of operation of the control device 100 in a case where the shutter 300 is open and closed depending on the schedule defined in the time table T12 and the opening and closing event will be described.

In the third example of operation, in a case where the shutter 300 is closed, the higher priority may be given to the time schedule defined in the time table T12 than to the occurrence of event. For example, even in a case where the closing event which causes the shutter 300 to close occurs, if the occurrence time of the closing event is in the time zone of the monitoring mode, the shutter 300 is continuously in the open state. In this way, it is possible to continuously monitor the privacy-sensing area and to give the priority to the securing of the security.

In addition, in a case where the opening event which causes the shutter 300 to open occurs, or in a case where the current time is in the time zone of the monitoring mode, the shutter 300 may be in the opening state. For example, in a case where the opening event occurs, the shutter 300 is in the open state regardless of the time schedule being in the monitoring mode or in the non-monitoring mode. In addition, in a case where the time schedule is the monitoring mode, the shutter 300 is in the open state regardless of the presence or the absence of the opening event. In this way, in a case where the event in which the need for monitoring is high occurs or in the time zone in which the need for monitoring is high, it is possible to quickly give higher priority to the securing of the security than to the protection of the privacy.

In addition, the operation of image recording and sound recording in the third example of operation is explained as follows.

In a case where the shutter 300 is in the open state, the camera device 200 captures the image by the image capturing element 210 and collects the sound by the microphone 240. On the other hand, in a case where the shutter 300 is in the closed state, the camera device 200 does not capture the image by the image capturing element 210 and does not collect the sound by the microphone 240.

In addition, in a case where the opening event occurs, the camera device 200 starts recording the captured image and starts recording the collected sound regardless of the current time being in the time zone of the monitoring mode or in the time zone of the non-monitoring mode. In addition, in a case where the closing event occurs, the camera device 200 stops recording the captured image and stops recording the collected sound regardless of the current time being in the time zone of the monitoring mode or in the time zone of the non-monitoring mode. In addition, in a case where the event does not occur and the operation mode transits to the monitoring mode or to the non-monitoring mode by the schedule, the state of image recording or sound recording immediately before the operation mode transition is continued.

Accordingly, when considering the operation of opening and closing of the shutter 300, in a case where the shutter 300 is in the open state caused by the occurrence of the opening event, until the closing event occurs while the schedule is the non-monitoring mode, the open state of the shutter 300 is continued. In addition, in a case where the shutter 300 is in the open state by the schedule, even if the closing event does not occur, when the operation mode transits to the non-operation mode by the schedule, the shutter 300 is in the closed state.

In addition, in a case where the operation mode transits to the monitoring mode by the schedule, the camera device 200 captures the image by the image capturing element 210 and collects the sound by the microphone 240, but does not perform the recording of the captured image and the recording of the collected sound. That is, the transition to the monitoring mode by the schedule has an intention of monitoring at all times, but does not have an intention of recording.

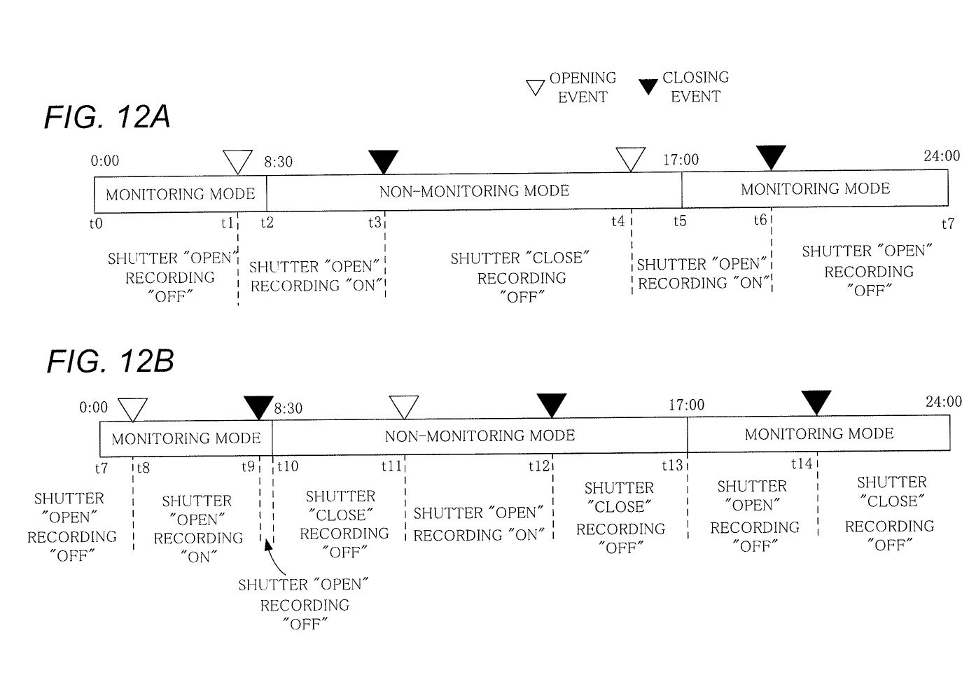

FIGS. 12A and 12B are schematic diagrams illustrating the operation modes, a status of event occurrences, the opening and closing states of the shutter 300, and the implementation states of the sound and image recordings in each time zone specified in the time table T12.

In FIG. 12A, the state is assumed that: a point in time t0 is an initial state, the operation mode defined in the time table T12 is “the monitoring mode”, the shutter 300 is in the open state, and the recording of the captured image and the recording of the collected voice are not performed (recording OFF).

At a point in time t1, the opening event (for example, the pressing of the emergency button) occurs. In this case, the shutter 300 continues to be in the open state. Therefore, the camera device 200 continues to capture the image and to collect the sound, and starts recording the image and the sound (recording ON).

The point in time t2 is a time point when the operation mode transits from the monitoring mode to the non-monitoring mode by the schedule. However, since the shutter 300 continues to be in the open state after the opening event occurs at the point in time t1, the shutter 300 continues to be in the open state after the point in time t2. In addition, the camera device 200 continues to capture the image and to collect the sound, and continues to perform the recording of the image and sound.

At a point in time t3, the closing event (for example, stopping of the pressing of the emergency button) occurs. In this case, the higher priority is given to the schedule than to the closing event. Since the point in time t3 is included in the time zone of non-monitoring mode, the shutter 300 is in the closed state. Therefore, the camera device 200 stops capturing the image and collecting the sound and stops recording the image and sound.

At a point in time t4, the opening event occurs. In this case, the shutter 300 is in the open state regardless of the schedule being the monitoring mode or the non-monitoring mode. Accordingly, the shutter 300 is in the open state. Therefore, the camera device 200 starts capturing the image and collecting the sound and starts recording the image and sound.

A point in time t5 is a time point when the operation mode transits from the non-monitoring mode to the monitoring mode by the schedule. At the point in time t5, the shutter 300 is already in the open state and the shutter 300 continues to be in the open state. Therefore, the camera device 200 continues to capture the image and to collect the sound and continues to record the image and sound.

At a point in time t6, the closing event occurs. In this case, the higher priority is given to the schedule than to the closing event. The point in time t6 is included in the time zone of the monitoring mode and the shutter 300 continues to be in the open state. Therefore, the camera device 200 continues to capture the image and to collect the sound. On the other hand, since the closing event occurs, the camera device 200 stops recording the image and sound.

In FIG. 12B, a point in time t7 is an initial state and is similar to the state of the point in time to.

At a point in time t8, the opening event occurs. In this case, the shutter 300 continues to be in the open state. Therefore, the camera device 200 continues to capture the image and to collect the sound and starts recording the image and sound.

At a point in time t9, the closing event occurs. In this case, the higher priority is given to the schedule than to the closing event. Since the point in time t9 is included in the time zone of the monitoring mode, the shutter 300 continues to be in the open state. Therefore, the camera device 200 continues to capture the image and to collect the sound. On the other hand, the camera device 200 stops recording the image and sound.

A point in time t10 is a time point when the operation mode transits to the non-monitoring mode from the monitoring mode by the schedule. Immediately before the point in time t10, the shutter 300 is in the open state. However, the closing event occurs at the point in time t9. Thus, at the point in time t10, the shutter 300 is in the closed state. Therefore, the camera device 200 stops capturing the image and collecting the sound. In addition, the camera device 200 continues not recording the image and sound.

At a point in time t11, the opening event occurs. In this case, the shutter 300 is in the open state regardless of the schedule being the monitoring mode or the non-monitoring mode. Accordingly, the shutter 300 is in the open state. Therefore, the camera device 200 starts capturing the image and collecting the sound, and starts recording the image and sound.

At a point in time t12, the closing event occurs. In this case, the higher priority is given to the schedule than to the closing event. Since the point in time t12 is included in the time zone of the non-monitoring mode, the shutter 300 is in the closed state. Therefore, the camera device 200 stops capturing the image and collecting the sound, and stops recording the image and sound.

A point in time t13 is a time point when the operation mode transits to the monitoring mode from the non-monitoring mode by the schedule. At the point in time t13, the shutter 300 is in the closed state and comes to be in the open state. Therefore, the camera device 200 starts capturing the image and collecting the sound, and continues not recording the image and sound.

At a point in time t14, the closing event occurs. In addition, the event occurring immediately before the point in time t14 is the closing event, and the operation mode transits to the monitoring mode at the point in time t13. Thus, the shutter 300 is in the open state. In this case, the higher priority may be given to the closing event than to the schedule instead of giving higher priority to the schedule than to the closing state. That is, at the point in time t14, the shutter 300 is in the closed state. Therefore, the camera device 200 may stop capturing the image and collecting the sound and continues not recording the image and sound. This operation can be realized, for example, by using an event flag described below. In this way, from before the closing event occurs at the point in time t14, the possibility of occurring the threat is low. Accordingly, the possibility of protecting the privacy while securing the security is high.

Moreover, in a case where the higher priority is given to the closing event than to the schedule, it is possible to further improve the security by going through a specific authentication process or an instruction of the monitoring center, for example.

Moreover, at the point in time t14, the higher priority may be given to the schedule than to the closing event. In this case, the point in time t14 is included in the time zone of the monitoring mode. Thus, the shutter 300 continues to be in the open state. Therefore, the camera device 200 continues to capture the image and to collect the sound and continues not recording the image and sound. In this way, it is possible to secure the security.

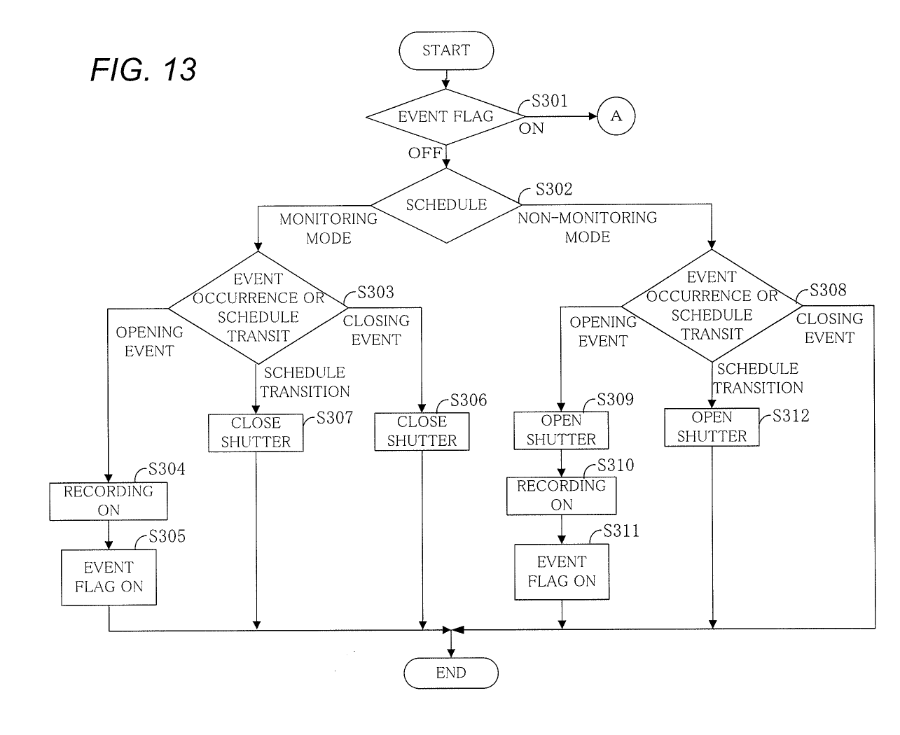

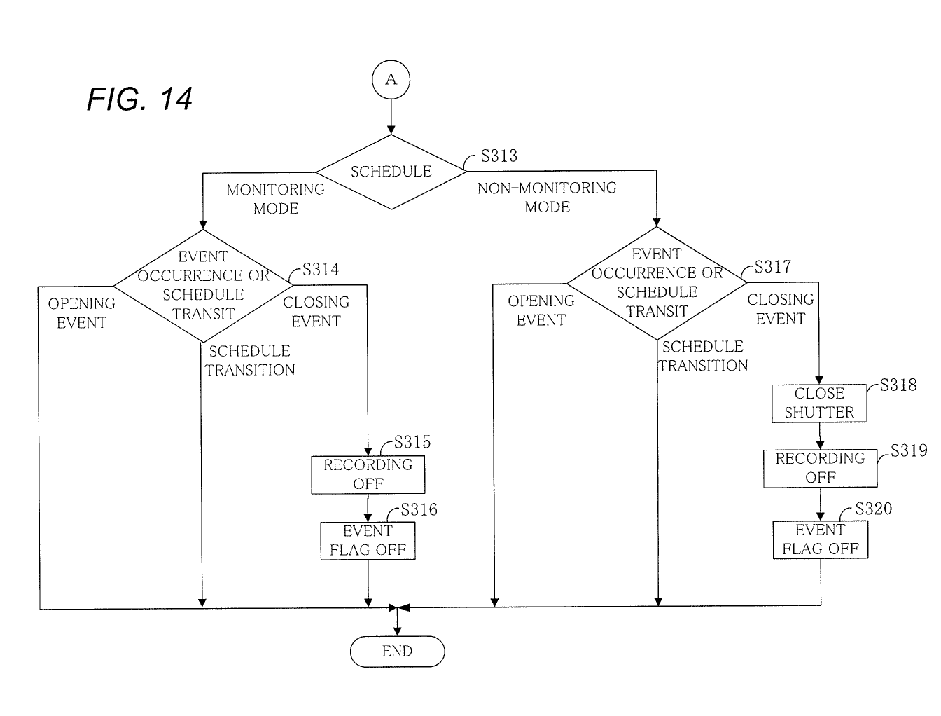

FIG. 13 and FIG. 14 are flowcharts illustrating the third example of operation of the control device 100 in a case where the shutter 300 is opened and closed. In a case where the occurrence of the event is detected or the transition of the operation mode according to the schedule is detected, the processing in FIG. 13 and FIG. 14 starts.

First, the event detection unit 120 refers to an event flag stored in the storage unit 150 (S301). In a case where the event flag is ON, that indicates that the previous event is the opening event. In a case where the event flag is OFF, that indicates that the previous event is not the opening event.

In a case where the event flag is OFF, the event detection unit 120 acquires information about the operation mode in the time zone where current time measured by the timer control unit 144 is included, referring to the time table T12 stored in the storage unit 150 (S302). Moreover, in a case where the event flag is OFF, the recording of the image and sound by the camera device 200 is in a state of being stopped.

In S302, in a case where the current time is included in the time zone of monitoring mode, the event detection unit 120 detects the presence or the absence of the event occurrence (opening event or closing event) or the presence or the absence of the operation mode transition (S303).

In S303, in a case where the occurrence of the opening event is detected, since the shutter 300 is in the opening state immediately before the opening event occurs in S303, even though the opening event occurs in S303, the shutter 300 continues to be in the same state.

In addition, the image and sound control unit 142 transmits, with respect to the camera device 200, a recording instruction signal instructing the camera device 200 to record the image and sound (S304). In addition, the event detection unit 120 sets the event flag to ON to be stored in the storage unit 150 (S305).

In the camera device 200, in a case where the communication unit 230 receives the recording instruction signal from the control device 100, the image and sound control unit 228 causes the camera device 200 to start recording the captured image and the collected sound.

In S303, in a case where the occurrence of the closing event is detected, the shutter control unit 141 transmits, with respect to the shutter 300, a closing instruction signal instructing the shutter 300 to be closed (S306). In addition, the image and sound control unit 142 transmits, with respect to the camera device 200, a capturing stop instruction signal which instructs the camera device 200 to stop capturing the image and collecting the sound.

In a case where the shutter 300 receives the closing instruction signal from the control device 100, the shutter 300 closes and the camera lens 260 is in the obstructed state. In addition, in a case where the capturing stop instruction signal from the control device 100 is received through the communication unit 230, the camera device 200 stops capturing the image by the image capturing element 210 and collecting the sound by the microphone 240.

In addition, in S303, in a case where the occurrence of the event is not detected, that is, in a case where the operation mode transits by the schedule, the shutter control unit 141 transmits the closing instruction signal with respect to the shutter 300 (S307). In addition, the image and sound control unit 142 transmits the capturing stop instruction signal with respect to the camera device 200.

In S302, in a case where current time is included in the time zone of the non-monitoring mode, the event detection unit 120 detects the presence or the absence of the occurrence of the event or the presence or the absence of the operation mode transition (S308).

In S308, in a case where the opening event is detected, the shutter control unit 141 transmits, with respect to the shutter 300, the opening instruction signal instructing the opening of the shutter 300 (S309). In addition, the image and sound control unit 142 transmits, with respect to the camera device 200, the capturing instruction signal instructing the camera device 200 to capture the image and to collect the sound.

In a case where the shutter 300 receives the opening instruction signal from the control device 100, the shutter 300 opens and causes the camera lens 260 to be in the exposed state. In addition, in a case where the communication unit 230 receives the capturing instruction signal from the control device 100, the camera device 200 starts capturing the image by the image capturing element 210 and collecting the sound by the microphone 240.

In addition, the image and sound control unit 142 transmits, with respect to the camera device 200, the recording instruction signal instructing the camera device 200 to capture the image and to collect the sound (S310). In addition, the event detection unit 120 sets the event flag to ON to be stored in the storage unit 150 (S311).

In S308, in a case where the occurrence of the closing event is detected, since the shutter 300 is in the closed state immediately before the closing event occurs in S308, even though the closing event occurs in S308, the shutter 300 continues to be in the same state.

In S308, in a case where the occurrence of the event is not detected, that is, in a case where the operation mode transits by the schedule, the shutter control unit 141 transmits the opening instruction signal with respect to the shutter 300 (S312). In addition, the image and sound control unit 142 transmits the capturing instruction signal with respect to the camera device 200.

On the other hand, in S301, in a case where the event flag is ON, the event detection unit 120 acquires information about the operation mode in the time zone where current time is included, referring to the time table T12 stored in the storage unit 150 (S313). In a case where the event flag is ON, the recording of the image and sound by the camera device 200 is in a state of being performed.

In S313, in a case where the current time is included in the time zone of monitoring mode, the event detection unit 120 detects the presence or the absence of the event occurrence, or the presence or the absence of the operation mode transition (S314).

In S314, in a case where the occurrence of the opening event is detected, since the shutter 300 is in the opening state immediately before the opening event occurs in S314, even though the opening event occurs in S314, the shutter 300 continues to be in the same state.

In S314, in a case where the occurrence of the closing event is detected, the priority is given to the schedule, since the schedule is the monitoring mode immediately before the closing event occurs in S314, even though the closing event occurs in S314, the shutter 300 continues to be in the same state.

In addition, the image and sound control unit 142 transmits, with respect to the camera device 200, a recording stop instruction signal which instructs the camera device 200 to stop recording the image and sound (S315).

In the camera device 200, in a case where the communication unit 230 receives the recording stop instruction signal from the control device 100, the image and sound control unit 228 causes the camera device 200 to stop recording the captured image and the collected sound.

In addition, the event detection unit 120 sets the event flag to OFF to be stored in the storage unit 150 (S316).

In S314, in a case where the occurrence of the event is not detected, that is, in a case where the operation mode transits by the schedule, the shutter 300 is in the open state by the opening event immediately before the operation mode transits by the schedule in S314. Accordingly, even though the operation mode transits by the schedule in S314, the shutter 300 continues to be in the same state.

In S313, in a case where the current time is included in the time zone of non-monitoring mode, the event detection unit 120 detects the presence or the absence of the event occurrence, or the presence or the absence of the operation mode transition (S317).

In S317, in a case where the occurrence of the opening event is detected, since the shutter 300 is in the opening state immediately before the opening event occurs in S317, even though the opening event occurs in S317, the shutter 300 continues to be in the same state.

In S317, in a case where the occurrence of the closing event is detected, the priority is given to the schedule. Since the schedule is the non-monitoring mode immediately before the closing event occurs in S317, the shutter control unit 141 transmits the closing instruction signal with respect to the shutter 300 (S318). The image and sound control unit 142 transmits the capturing stop instruction signal with respect to the camera device 200. The image and sound control unit 142 also transmits the recording stop instruction signal with respect to the camera device 200 (S319). In addition, the event detection unit 120 sets the event flag to OFF to be stored in the storage unit 150 (S320). That is, the closing event invalidates the opening-event-dependent state of the camera device 200 and the shutter 300.

In S317, in a case where the occurrence of the event is not detected, that is, in a case where the operation mode transits by the schedule, the shutter 300 is in the open state by the opening event immediately before the operation mode transits by the schedule in S317. Accordingly, even though the operation mode transits by the schedule in S317, the shutter 300 continues to be in the same state.

In each step in FIG. 13 and FIG. 14, even in a case where the states are not changed before or after the instruction for opening or closing the shutter 300, instruction for image capturing and sound collecting, and instruction for recording the image and sound to the camera device 200, each instruction signal may be transmitted. For example, in a case where the instruction for shutter is “open” to “open” or the instruction for recording the image and sound is “stop” to “stop”, the instruction signal may be transmitted. In the embodiment, controlling the shutter 300 to open may indicate both states where the shutter 300 opens from a closed state and where the shutter 300 remains unchanged from an opened state. Similarly, controlling the shutter 300 to close may indicate both states where the shutter 300 closes from an opened state and where the shutter 300 remains unchanged from a closed state.

In addition, the transmission of the capturing instruction signal or the capturing stop instruction signal according to the opening and closing of the shutter 300 may be omitted, and the capturing by the camera device 200 may be performed at all times. Even in this case, the image capturing area is limited as desired, by opening and closing the shutter 300.

According to the third example of operation of the control device 100, by combining the control of the opening and closing of the shutter 300 using the time table T12 and the control of the opening and closing of the shutter 300 based on the event, it is possible to improve the security securing level and privacy protection level. For example, in a case where the opening event occurs, a dangerous situation can be estimated, and that makes it difficult to close the shutter 300, and to stop capturing and recording the image by the camera device 200 and collecting and recording the sound by the microphone 240. In this way, the priority can be given to the security securing in the dangerous situation.

In addition, since the shutter 300 is not opened nor closed merely according to the predetermined schedule, it is possible to improve the privacy protection level or security securing level. For example, in the office, even in a case where a person is not usually present in the monitoring area in the late night time zone, there is a possibility that an employee is present in the monitoring area on a specific day. Even in this case, it is possible to protect the privacy. In addition, even in a case where a person is usually present in the monitoring area in the day time zone, there is a possibility that an employee is not present in the monitoring area on a specific day. Even in this case, it is possible to secure the security.

Moreover, the present invention is not limited to the configurations in the embodiment described above. Any configurations with which the functions of the configuration in the embodiments can be achieved may be applicable.

For example, in the embodiment described above, the collecting and the recording of the sound by the microphone in the camera device 200 may be omitted.

In addition, in the embodiment described above, the priority to the event and priority to the schedule may be reversed. For example, when the shutter 300 is in the open state, the priority may be given to the schedule. In this case, even when the opening event is detected, if the operation mode does not transit to the monitoring mode by the schedule, the shutter 300 is not opened. In this way, the priority can be given to the security securing.

In addition, in the embodiment described above, it is assumed that the closing event or the closing schedule (non-monitoring mode) exists, and the duration of the closing event may be set in advance. In this case, the shutter 300 may be in the closed state after the predetermined duration from the start of the opening event or start of the monitoring mode.

In addition, in the embodiment described above, a case is illustrated where the various instruction signals are transmitted from the control device 100 with respect to the camera device 200 and the shutter 300, and the camera device 200 and the shutter 300 operate based on such instruction signals. Alternatively, for example, the camera device 200 may have the schedule in the camera device 200 itself and detect various events to operate independently.

A summary of the configurations of aspects of the present invention will be described as below.

A first aspect of the present invention provides a monitoring apparatus to be connected to a shutter which opens and closes to limit a capturing area of an image capturing device, the monitoring apparatus including: an event detector, configured to detect an event indicative of a closing event or an opening event, wherein the closing event is provided to narrow the capturing area of the image capturing device, and the opening event is provided to widen the capturing area of the image capturing device; and a first controller, configured to control the shutter to open and close based on a given time schedule and the event detected by the event detector, wherein the time schedule determines each period for opening and closing the shutter, wherein the first controller controls the shutter based on the opening event in response to a detection of the opening event by the event detector, and controls the shutter based on the time schedule in response to a detection of the closing event when the opening event is last detected before the detection of the closing event by the event detector.

According to this configuration, even in a case where a situation is different from the situation which is assumed based on the time zone, it is possible to protect the privacy or to secure the security with the priority in response to the event (for example, the event in which the threat level is high or low). In addition, even in a case where the situation is different from the situation which is assumed based on the event, it is possible to protect the privacy or to secure the security with the priority in accordance with the schedule. Therefore, it is possible to improve the level of the privacy protection or the security securing. In addition, by giving the priority to the opening event in which the possibility of the threat occurring is high, it is possible to give the priority to the security securing. In addition, in a case where the closing event is detected in which the possibility that the threat is finished is high, by giving the priority to the schedule, it is possible to achieve both of the privacy protection and the security securing.

The monitoring apparatus may be configured so that, in response to the detection of the opening event by the event detector, the first controller opens the shutter if the shutter is closed, and remains the shutter unchanged if the shutter is opened, and in response to the detection of the closing event after the detection of the opening event by the event detector, the first controller remains the shutter unchanged if the shutter is opened based on the time schedule.

According to this configuration, the control of opening and closing the shutter is appropriately performed depending on the opening and closing states of the shutter, the event detected by the event detector and the given time schedule.

The monitoring apparatus may be configured by further including a timer controller, configured to obtain a point of time, wherein while the point of time obtained by the timer controller is included in a first time zone, the first controller is configured to control the shutter to open in response to the detection of the opening event by the event detector, and to control the shutter to close in response to the detection of the closing event by the event detector, wherein the first time zone is a time zone when the shutter closes indicated by the time schedule, whereas while the point of time obtained by the timer controller is included in a second time zone, the first controller is configured to control the shutter to open in response to the detection of the opening event by the event detector, and to control the shutter to open in response to the detection of the closing event by the event detector, wherein the second time zone is a time zone when the shutter opens indicated by the time schedule.

According to this configuration, even in a case where the operation mode is in the non-monitoring mode by the schedule, by giving the higher priority to the event than to the schedule to which the time zone of low possibility of threat occurring is added, it is possible to secure the desired security and protect the desired privacy. In addition, even in a case where the operation mode is in the monitoring mode by the schedule, by giving the priority to the schedule to which the time zone of high possibility of threat occurring is added, it is possible to secure the security with the priority.

The monitoring apparatus may be configured so that when no event is detected by the event detector at a time for transiting an opening and closing state of the shutter based on the given time schedule and the closing event is last detected by the event detector, the first controller is configured to control the opening and closing of the shutter based on the time schedule after transition.

According to this configuration, in a case where the open and closed state of the shutter transits according to the schedule after the closing event occurs, the possibility that the threat exists is low. Accordingly, the shutter is opened or closed depending on whether or not the current time is included in the time zone in which the possibility of threat occurring is high. In this way, it is possible to achieve both of the privacy protection and the security securing.

The monitoring apparatus may be configured so that when no event is detected by the event detector at a time for transiting an opening and closing state of the shutter based on the given time schedule and the opening event is last detected by the event detector, the first controller is configured to control the shutter to open.

According to this configuration, in a case where the open and closed state of the shutter transits according to the schedule after the opening event occurs, the possibility that the threat exists is high. Accordingly, the priority is given to the immediately previous opening event. In this way, it is possible to secure the security with the priority.

The monitoring apparatus may be configured so that the first controller is configured to control the shutter to close in response to a consecutive detection of closing events by the event detector.

According to this configuration, in a case where the closing event continuously occurs, the possibility that the threat exists is low. Accordingly, it is estimated that the threat does not exist. Thus, the shutter is closed. In this way, it is possible to protect the privacy with the priority.

The monitoring apparatus may be configured so that the first controller is configured to control the shutter to close in response to the detection of the closing event by the event detector when the shutter is in an opened state based on the given time schedule, independently of the opening event.

According to this configuration, the shutter is opened according to the schedule, but it is estimated that the possibility that the threat exists is low. Accordingly, the shutter is closed in a case where the closing event occurs. In this way, it is possible to protect the privacy with the priority.

The monitoring apparatus may be configured by including a second controller, configured to record images captured by the image capturing device in a memory, wherein the second controller is configured to start or stop recording the images in response to the detection of the event by the event detector.

According to this configuration, the possibility of threat occurring is high. Accordingly, by starting the recording of the image, it is possible to retain the threat as image information. Further, the possibility that the threat does not exist any more or finished is high. Accordingly, it is possible to effectively use the storage by stopping the recording of the image.

The monitoring apparatus may be configured so that a sensor is connected to the monitoring apparatus, and the event detector is configured to detect the event based on information sent from the sensor.

According to this configuration, for example, the opening event or the closing event can be detected at the time point when the threat level is increased or decreased without the operation by the user, and it is possible to easily secure the privacy or security.

The monitoring apparatus may be configured by including a communication unit, configured to receive information, wherein the event detector is configured to detect the event based on the information received by the communication unit.

According to this configuration, for example, even before the event is detected by the sensor, the event can be detected at the time point when it is determined that the threat level increases or decreases. Accordingly, it is possible to realize the quick securing of the privacy or the security.

The monitoring apparatus may be configured by including a third controller, configured to record a sound collected by a microphone provided in an area in which the image capturing device is disposed, wherein the third controller starts or stop recording the collected sound in response to the event detected by the event detector.

According to this configuration, in a case where the possibility of the threat occurring is high, by starting the recording of the sound, it is possible to retain the threat as sound information.

The monitoring apparatus may be configured by further including: a second controller, configured to record images captured by the image capturing device in a memory; and a third controller, configured to record a sound collected by a microphone provided in an area in which the image capturing device is disposed, wherein the first, second and third controller are operated in accordance with an operation mode indicated by the given time schedule.

According to this configuration, it is possible to determine the opening or closing of the shutter depending on whether or not the current time is included in the time zone in which the need for monitoring is high.

A second aspect of the present invention provides a monitoring system including: an image capturing device; a shutter which opens and closes to limit a capturing area of the image capturing device; and a monitoring apparatus which is connected to the shutter and controls the shutter, wherein the monitoring apparatus includes: an event detector, configured to detect an event indicative of a closing event or an opening event, wherein the closing event is provided to narrow the capturing area of the image capturing device, and the opening event is provided to widen the capturing area of the image capturing device; and a first controller, configured to control the shutter to open and close based on a given time schedule and the event detected by the event detector, wherein the time schedule determines each period for opening and closing the shutter, wherein the first controller controls the shutter based on the opening event in response to a detection of the opening event by the event detector, and controls the shutter based on the time schedule in response to a detection of the closing event when the opening event is last detected before the detection of the closing event by the event detector.

According to this configuration, even in a case where a situation is different from the situation estimated based on the time zone, it is possible to protect the privacy or to secure the security in response to the event (for example, the event for which the threat level is high or low). Even in a case where the situation is different from the situation estimated based on the event, it is possible to protect the privacy or to secure the security in accordance with the schedule. Therefore, it is possible to improve the level of the privacy protection or the security securing. In addition, by giving the priority to the opening event in which the possibility of the threat occurring is high, it is possible to secure the security with the priority. In addition, in a case where the closing event in which the possibility that the threat is finished is high is detected, by giving the priority to the schedule, it is possible to achieve both of the privacy protection and the security securing.

The monitoring system may be configured so that the image capturing device has a capturing lens, and the shutter exposes or obstructs the capturing lens to change the capturing area of the image capturing device.

According to this configuration, in a case where the shutter is in the open state, the image capturing lens is exposed. Accordingly, for example, it is possible to cause a suspicious visitor to recognize that he is monitored at that time. In addition, in a case where the shutter is in the closed state, the image capturing lens is obstructed. Accordingly, it is possible to prevent the person other than the suspicious visitor from having a feeling of discomfort that he/she is monitored at that time.

The monitoring system may be configured so that the image capturing device and the shutter are covered with a housing, and optionally the housing includes an enclosure and a transparent cover.

According to this configuration, the monitoring apparatus can perform a total control of the shutter to open and close in order to limit the image capturing area of the image capturing device.

A third aspect of the present invention provides a monitoring method in a monitoring apparatus to be connected to a shutter which opens and closes to limit a capturing area of an image capturing device, the monitoring method including: detecting an event indicative of a closing event or an opening event, wherein the closing event is provided to narrow the capturing area of the image capturing device, and the opening event is provided to widen the capturing area of the image capturing device; and controlling the shutter to open and close based on a given time schedule and the detected event, wherein the time schedule determines each period for opening and closing the shutter, wherein the shutter is controlled based on the opening event in response to a detection of the opening event, and the shutter is controlled based on the time schedule in response to a detection of the closing event when the opening event is last detected before the detection of the closing event.

According to this configuration, even in a case where a situation is different from the situation estimated based on the time zone, it is possible to protect the privacy or to secure the security in response to the event (for example, the event for which the threat level is high or low). In addition, even in a case where the situation is different from the situation estimated based on the event, it is possible to protect the privacy or to secure the security in accordance with the schedule. Therefore, it is possible to improve the level of the privacy protection or the security securing. In addition, by giving the priority to the opening event in which the possibility of the threat occurring is high, it is possible to secure the security with the priority. In addition, in a case where the closing event is detected in which the possibility that the threat is finished is high, by giving the priority to the schedule, it is possible to achieve both of the privacy protection and the security securing.

What is claimed is:

1. A monitoring apparatus to be connected to a shutter which opens and closes to limit a capturing area of an image capturing device, the monitoring apparatus comprising:
an event detector, configured to detect an event indicative of a closing event or an opening event, the closing event being provided to narrow the capturing area of the image capturing device, and the opening event being provided to widen the capturing area of the image capturing device; and
a first controller, configured to control the shutter to open and close based on a given time schedule and the event detected by the event detector, wherein
the time schedule determines each period for opening and closing the shutter, and
the first controller controls the shutter based on the opening event in response to a detection of the opening event by the event detector, and controls the shutter based on the time schedule in response to a detection of the closing event, and
when the opening event is detected before the detection of the closing event by the event detector, the first controller controls the shutter based on the time schedule in response to a detection of the closing event.

2. The monitoring apparatus according to claim 1, wherein
in response to the detection of the opening event by the event detector, the first controller opens the shutter if the shutter is closed, and remains unchanged if the shutter is opened, and
in response to the detection of the closing event after the detection of the opening event by the event detector, the shutter remains unchanged if the shutter is opened based on the time schedule.

3. The monitoring apparatus according to claim 1, further comprising:
a timer controller, configured to obtain a point of time, wherein
while the point of time obtained by the timer controller is included in a first time zone, the first controller is configured to control the shutter to open in response to the detection of the opening event by the event detector, and to control the shutter to close in response to the detection of the closing event by the event detector, wherein the first time zone is a time zone when the shutter closes indicated by the time schedule, whereas
while the point of time obtained by the timer controller is included in a second time zone, the first controller is configured to control the shutter to open in response to the detection of the opening event by the event detector, and to control the shutter to open in response to the detection of the closing event by the event detector, wherein the second time zone is a time zone when the shutter opens indicated by the time schedule.

4. The monitoring apparatus according to claim 1, wherein
when no event is detected by the event detector at a time for transiting an opening and closing state of the shutter based on the given time schedule and the closing event is last detected by the event detector, the first controller is configured to control the opening and closing of the shutter based on the time schedule after transition.

5. The monitoring apparatus according to claim 1, wherein
when no event is detected by the event detector at a time for transiting an opening and closing state of the shutter based on the given time schedule and the opening event is last detected by the event detector, the first controller is configured to control the shutter to open.

6. The monitoring apparatus according to claim 1, wherein
the first controller is configured to control the shutter to close in response to a consecutive detection of closing events by the event detector.

7. The monitoring apparatus according to claim 1, wherein
the first controller is configured to control the shutter to close in response to the detection of the closing event by the event detector when the shutter is in an opened state based on the given time schedule, independently of the opening event.

8. The monitoring apparatus according to claim 1, further comprising:
a second controller, configured to record images captured by the image capturing device in a memory, wherein
the second controller is configured to start or stop recording the images in response to the detection of the event by the event detector.

9. The monitoring apparatus according to claim 1, wherein
a sensor is connected to the monitoring apparatus, and
the event detector is configured to detect the event based on information sent from the sensor.

10. The monitoring apparatus according to claim 1, further comprising
a communication unit, configured to receive information, wherein
the event detector is configured to detect the event based on the information received by the communication unit.

11. The monitoring apparatus according to claim 1, further comprising:
a third controller, configured to record a sound collected by a microphone provided in an area in which the image capturing device is disposed, wherein
the third controller starts or stop recording the collected sound in response to the event detected by the event detector.

12. The monitoring apparatus according to claim 1, further comprising:
a second controller, configured to record images captured by the image capturing device in a memory; and
a third controller, configured to record a sound collected by a microphone provided in an area in which the image capturing device is disposed, wherein
the first, second and third controller are operated in accordance with an operation mode indicated by the given time schedule.

13. A monitoring system comprising:
an image capturing device;
a shutter which opens and closes to limit a capturing area of the image capturing device; and
a monitoring apparatus which is connected to the shutter and controls the shutter, wherein
the monitoring apparatus comprises:
an event detector, configured to detect an event indicative of a closing event or an opening event, the closing event being provided to narrow the capturing area of the image capturing device, and the opening event being provided to widen the capturing area of the image capturing device; and
a first controller, configured to control the shutter to open and close based on a given time schedule and the event detected by the event detector, wherein
the time schedule determines each period for opening and closing the shutter, and
the first controller controls the shutter based on the opening event in response to a detection of the opening event by the event detector, and controls the shutter based on the time schedule in response to a detection of the closing event, and
when the opening event is detected before the detection of the closing event by the event detector, the first controller controls the shutter based on the time schedule in response to a detection of the closing event.

14. The monitoring system according to claim 13, wherein
the image capturing device has a capturing lens, and the shutter exposes or obstructs the capturing lens to change the capturing area of the image capturing device.

15. The monitoring system according to claim 13, wherein
the image capturing device and the shutter are covered with a housing.

16. The monitoring system according to claim 15, wherein
the housing includes an enclosure and a transparent cover.

17. A monitoring method in a monitoring apparatus to be connected to a shutter which opens and closes to limit a capturing area of an image capturing device, the monitoring method comprising:
detecting an event indicative of a closing event or an opening event, the closing event being provided to narrow the capturing area of the image capturing device, and the opening event being provided to widen the capturing area of the image capturing device; and
controlling the shutter to open and close based on a given time schedule and the detected event, wherein
the time schedule determines each period for opening and closing the shutter,
the shutter is controlled based on the opening event in response to a detection of the opening event, and
when the opening event is detected before the detection of the closing event, the shutter is controlled based on the time schedule in response to a detection of the closing event.
